(19) United States
(12) Patent Application Publication
(10) Pub. No.: US 2015/0152898 A1
(43) Pub. Date: Jun. 4, 2015

(54) DEVICE FOR EMERGENCY OPERATION OF ACTUATORS

(71) Applicant: ALSTOM Technology Ltd., Baden (CH)

(72) Inventors: Slaven BANAY, Gebenstorf (CH); Eduard Burch, Wurenlos (CH); Roger Bauer, Zurich (CH)

(21) Appl. No.: 14/557,840

(22) Filed: Dec. 2, 2014

(30) Foreign Application Priority Data
Dec. 3, 2013 (EP) 13195437.2

(51) Int. Cl. F15B 20/00; F02C 7/00

(52) U.S. Cl. CPC F15B 20/004; F15B 20/008; F02C 7/00

(57) ABSTRACT

A device for emergency operation of pneumatic or hydraulic actuators. For normal operation of the actuator, an operation cycle includes at least a proportional valve for switching to different operational conditions of the actuator and related engine components. The proportional valve is arranged in a supply line of pressurized liquid/gas and in a drain line connected to a tank, and control means for operation control and supervising functions. An emergency cycle is attached to the operation cycle of the actuator which is provided with: at least one solenoid valve for initiating an emergency operation impulse in case of detected failures; a plurality of pneumatically/hydraulically operated switch valves which may be activated through said impulse of an emergency signal from said solenoid valve; and whereby the emergency cycle is adapted to bypass said proportional valve in emergency situations and to either block said actuator in its actual position or to bring said actuator in a predefined safe position.

### CROSS-REFERENCE TO RELATED APPLICATIONS

This application claims priority to European application 13195437.2 filed Dec. 3, 2013, the contents of which are hereby incorporated in its entirety.

### TECHNICAL FIELD

The present invention relates to a device for an emergency operation of pneumatic or hydraulic actuators according to the preamble of claim 1. Such hydraulic actuators are, for example, used for the operation of different engine components, for example for the actuation of variable inlet guide vanes of gas turbines.

### BACKGROUND

For the operation and control of such actuators, it is conventionally known to provide an operation cycle including at least a proportional valve for switching to different operational conditions of the actuator and the related engine components, wherein the proportional valve is arranged in a supply line of pressurized liquid or gas and in a drain line connected to a tank of the operation cycle, and in which control means are provided for different control and supervision functions. During the normal operation of such hydraulic actuators, the proportional valve is used as a control means for switching the actuator, for example, from an open position to a closed position of the actuator and thereby the connected related engine parts. For the purpose of a position control of such actuators, there are conventionally provided sensors and position detectors, for example angle position transducers. These sensors supply an input signal to the control means of the operation cycle such that the correct positioning of the related engine parts can be set by means of the operation of the actuator.

In some situations, however, the correct control of the proportional valve and the hydraulic actuator is not possible: for example, in a case where the sensors or position detectors of the engine parts do not function anymore or do not provide the correct values, the control of the proportional valve will immediately get incorrect. Also in a case where the proportional valve of the operation cycle has a failure, e.g. a control electronics failure occurs, the normal operation of the actuator and engine components is not possible anymore. Such situations are also given in cases where the signal data quality of the sensors or the position detectors is bad. In all these cases, the prior art devices for an operation of, for example, hydraulic actuators in gas turbines give rise to a high risk of a damaging of engine parts, because the normal control system is not able anymore to bring the actuators in a required safe position, for example a closed position of variable inlet guide vanes of compressors of gas turbines. In such a case, for example, when the angle transducers (position sensors) indicate false measurements of the actual positioning of the guide vanes, the conventional control of such devices is blocked, and the engine or gas turbine is tripped. The gas turbine will thereby coast down with open variable inlet guide vanes of the compressor, which has a high potential of a rotation stall and which therefore may cause severe damages to the compressor or other parts of the gas turbine.

In view of these disadvantages of the prior art solutions, it is the problem of the present invention to provide a device for an emergency operation of pneumatic or hydraulic actuators of, for example, engine components of gas turbines, which efficiently avoids damages and undesired operational situations of the actuators in case of failures of the normal operation modus of the actuators. In particular, the problem underlying the present invention is to provide a safe emergency operation modus for such pneumatic or hydraulic actuators.

This problem is solved by means of a device with the features of claim 1. Further developments and advantageous forms of realization of the invention are the subject matter of the dependent claims.

### SUMMARY OF THE INVENTION

The device for an emergency operation of pneumatic or hydraulic actuators according to the invention is provided with an operation cycle for the normal operation, including at least a proportional valve for switching to different operational conditions of the actuator and the related engine components connected to the actuator, whereby the proportional valve is arranged in a supply line of pressurized liquid/gas and in a drain line connected to a tank, and whereby control means for operation control and supervising functions are provided, the device of the invention being characterized in that an emergency cycle is attached to said operation cycle of said actuator, which is provided with: at least one solenoid valve for initiating an emergency operation impulse in case of detected failures; a plurality of pneumatically/hydraulically operated switch valves, which may be activated through said impulse of an emergency signal from said solenoid valve; and whereby the emergency cycle is adapted to bypass said proportional valve in emergency situations and to either block said actuator in its actual position or to bring said actuator in a predefined safe position. In case of failures, for example with regard to the proportional valve or to detection means of the control means, the device according to the invention switches directly from the normal operation cycle to the additional emergency cycle, which is adapted to execute specific predefined safety functions: the emergency cycle comprises in particular a solenoid valve for initiating an emergency operation impulse, i.e. for starting the switching from the normal operation cycle to the emergency cycle. Furthermore, the emergency cycle is provided with a plurality of pneumatically or hydraulically operated switch valves, which are connected to the normal operation cycle and the emergency cycle such that they may be activated through the impulse of an emergency signal from said solenoid valve in such a manner that the proportional valve is bypassed in the emergency situation and that the actuator is either blocked in its actual position or is brought into a predefined safe position.

Upon assessment of a failure in the normal system, the solenoid valve will be actuated, either manually or automatically, and consequently an impulse of emergency situation will be sent to the switch valves, which will then change the operation modus from the normal operation to the emergency operation. In this emergency operation modus, the normal proportional valve, serving as a control means for the actuator, is put out of function, and the actuator is brought into the desired safe emergency position. A safe emergency position of the actuator is either a blocked position at the actual position in the time of the failure, or a predefined end position, in the case of a hydraulic actuator of the cylinder/piston type, for example, a completely extended position of the actuator. By means of this emergency device, the engine components, for example the variable inlet guide vanes of a compressor in a gas turbine, may be brought into a closed safe position, which prevents any damages to the engine components due to the necessary rundown of the gas turbine. Through the device for an emergency operation according to the invention, a kind of combined electronic and hydraulic (or pneumatic) safety backup system is provided. With the invention, an immediate switching from a normal operation to an emergency operation is enabled. The related engine components connected to the actuators are directly put into a safe position, in which the failure of the operation cycle or components of the operation cycle does not lead to any damages to the different components of the engine. This switching into an emergency operation according to the invention functions independently of the proportional valve (control means) of the normal operation cycle such that even in case of problems with regard to this proportional valve the actuator is nevertheless brought into a safe emergency position.

According to an advantageous aspect of the invention, means for the detection of a correct functioning of said actuator are provided for supplying an input signal or emergency signal to said control means of the device. Such means for the detection of a correct functioning may, for example, be realized in position sensors, angle position transducers or other software or hardware sensor means. These means according to the invention provide information in view of problems of the normal operation, any failure of components, false signal data, or the like. In case of problems in the normal operation modus, the means provide an input signal or emergency signal to said control means of the device for an emergency operation according to the invention such that an immediate switching into a safe emergency operation modus can be initiated and carried out.

According to a further advantageous aspect of the invention, the control means of the device are connected to said at least one solenoid valve for switching automatically to an emergency operation in case of failures in the normal operation modus of said actuator. By means of this, the safety of an operation of the actuators and the related engine components is even more increased. Immediately after the occurrence of a failure or problem in the components of the normal system, the device switches to the emergency cycle, in which the normal proportional valve is bypassed and the actuator is brought into a predefined safe position.

According to a further advantageous aspect of the invention, the emergency cycle of the device is provided with a first solenoid valve such that upon activation of this first solenoid valve the actuator is blocked in its actual position. This avoids any further movement of the actuator such that the actual situation of the time of a failure is maintained in the emergency operation modus. The actuation of the first solenoid valve leads to an activation of the for example hydraulically operated switch valves in positions, in which the actuator is put into a blocking position. This blocking of the actual position of the actuator is thereby independent of the position of the proportional valve of the normal operation cycle such that this safety function can be realized also in cases where problems arise with regard to this proportional valve.

According to a further advantageous aspect of the invention, the emergency cycle is provided with a first solenoid valve and a second solenoid valve, which are provided such that upon a simultaneous activation of these solenoid valves the actuator is brought into a predefined safe position, in particular an end position of the actuator. By means of this, the emergency function of the device can be chosen selectively. The actuator may be put into a predefined safe position in case of a failure of components or false information in the data of sensors. Such a safe predefined position of the actuator may, for example, be a completely extended position of the piston of a hydraulic actuator, which usually is a closed position of the connected related engine components of a compressor of a gas turbine, or the like. This has the advantage that damages due to the failure in the system can be avoided. Immediately after detection of a problem, the device according to the invention switches into the operation of the emergency cycle, in which the safe position of the actuator is obtained.

According to a further advantageous aspect of the invention, the predefined safe position, into which the emergency cycle sets the actuator, is an extended position of said actuator corresponding in particular to a closed position of related engine components. These engine components may, for example, be inlet guide vanes of a compressor or a turbine. The hydraulic actuator for opening and closing the variable inlet guide vanes is upon failure of the system brought in the predefined safe position, which is an extended position of the actuator and which corresponds to a closing of these guide vanes. Hereby, any damage to the compressor and the turbine components due to an inadmissible rotation stall is effectively avoided.

According to a further advantageous aspect of the invention, the emergency cycle of the device comprises a flow control valve for adjusting a switching speed of the switching from a normal operation to an emergency operation in case of a failure in the system. The flow control valve may, for example, be a manually adjustable orifice, which is arranged in a drain line of the cycle. With this flow control valve of the emergency cycle, the speed of a change into the emergency operation may be set. Thereby, for example, the emergency closing rate in case of the closing of the variable inlet guide vanes of a compressor of a gas turbine may be determined in terms of the time necessary to achieve the final safe position. By setting the flow control valve manually, the speed of the change from the normal operation into the emergency operation can individually be adapted to the respective situation and type of engines.

According to a further advantageous aspect of the invention, the control means of the device are adapted to interrupt the emergency operation and to resume normal operation upon request of a user. In this manner, at any time of the emergency operation, the system may be brought back into the normal operation modus, for example in case the failure has already been repaired or removed.

According to a further advantageous aspect of the invention, a detector for supervising the position of said proportional valve of the normal operation cycle is provided. By means of such a detector for supervising the position of the proportional valve, this detector can be provided as a direct sensor on the proportional valve or can be indirectly realized by means of for example an angle position transducer on the side of the related engine components, for example the variable inlet guide vanes. The supervising of the position of the proportional valve further increases the safety of the operation of such actuators, since also deviations between the position in the engine parts and the position of the proportional valve can be detected and can in an advantageous manner serve for the control of the emergency cycle or normal cycle of the device.

According to a further advantageous aspect of the invention, the actuator is a hydraulic actuator of a variable inlet guide vane of a gas turbine. The inlet guide vanes will automatically be closed in case of a problem or failure in the system due to the direct switching from the normal cycle into the emergency cycle. Any damage to the components of the gas turbine and namely the parts of the compressor is hereby avoided. The invention is certainly also applicable to other types or components of engines or machines. The actuator according to the present invention may be a hydraulic actuator or a pneumatic actuator, and the realization of the emergency function by means of the emergency cycle according to the present invention requires only the adaption of the respective hydraulic or pneumatic cycles depending on the respective situations and type of related engine parts.

### BRIEF DESCRIPTION OF THE DRAWINGS

In the following, the invention will be described in more detail on the basis of an example of realization shown in the attached drawings. In the drawings shows

FIG. 1 a schematic hydraulic diagram of an example of realization of a device according to the invention in a normal operation closing modus;

FIG. 2 a schematic hydraulic diagram of an example of realization of a device according to the invention in a normal operation opening modus;

FIG. 3 a schematic hydraulic diagram of an example of realization of a device according to the invention in an emergency operation blocking modus;

FIG. 4a a schematic hydraulic diagram of an example of realization of a device according to the invention in an emergency operation closing modus (part 1); and

FIG. 4b a schematic hydraulic diagram of an example of realization of a device according to the invention in an emergency operation closing modus (part 2).

### DETAILED DESCRIPTION

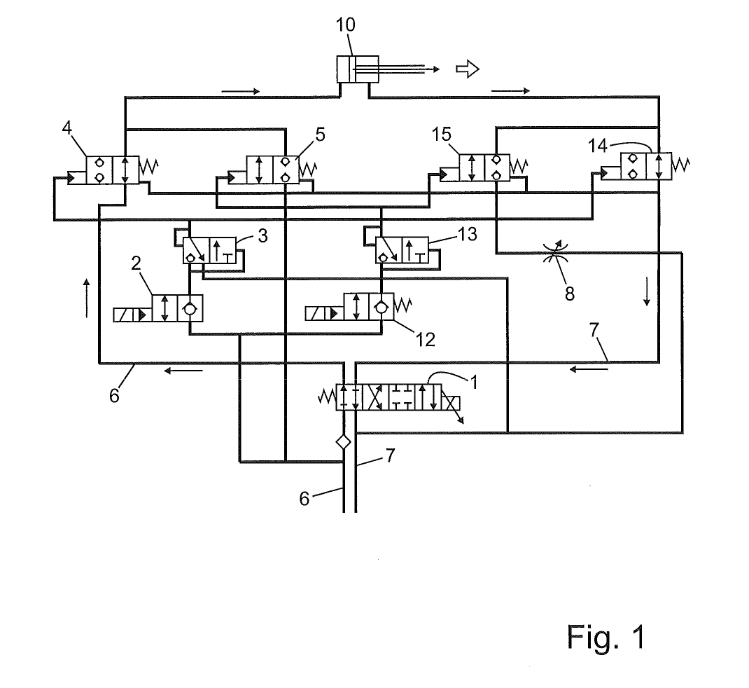

An example of realization of a device for an emergency operation of a hydraulic actuator 10 is shown in different operational situations in the schematic hydraulic diagrams of FIG. 1 to FIG. 4b. The respective active hydraulic lines are in the drawings indicated with thicker lines and flow arrows for the purpose of a better understanding.

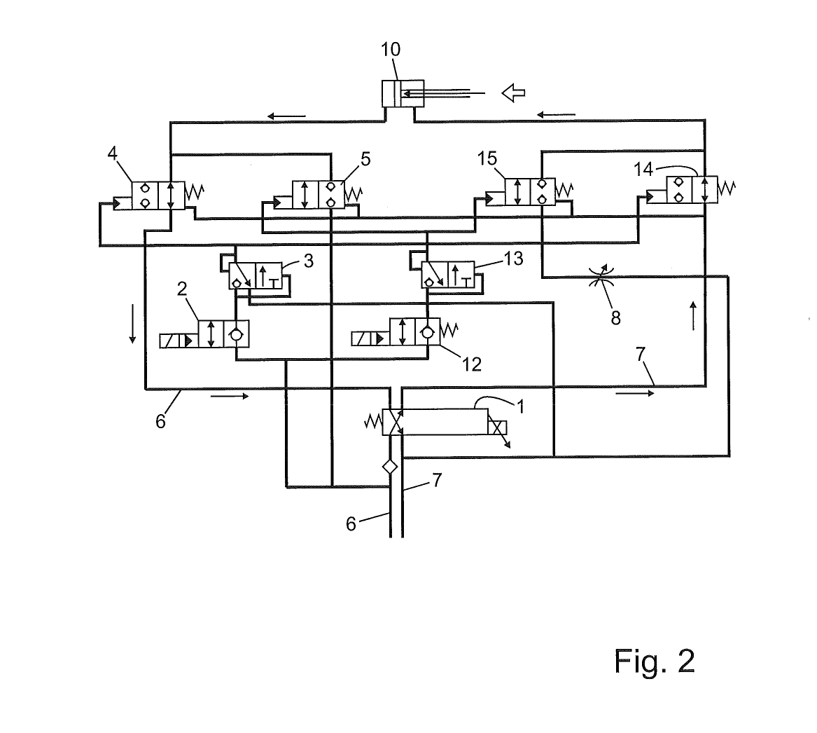

In FIG. 1 and FIG. 2, the example of realization of an emergency device according to the invention is shown in a normal operation, i.e. without any failures in the hydraulic system or with regard to components of a device, wherein FIG. 1 shows the normal operation closing modus for the hydraulic actuator 10 and FIG. 2, on the contrary, the normal operation opening modus of the hydraulic actuator 10.

For the normal operation and control of the hydraulic actuator 10, the device is provided with a proportional valve 1, which is mounted in a hydraulic supply line 6 and in a hydraulic drain line 7, which are connected to a means for pressurizing a hydraulic liquid and to a tank, respectively. The proportional valve 1 is connected to a control means (not shown), by means of which different operational conditions can be set. During the normal operation, the proportional valve 1 is switched between a closing modus, an opening modus, a blocking modus, or the like in order to control the hydraulic actuator 10. In this example of realization, the hydraulic actuator 10 is of the type piston/cylinder and serves for the actuation of variable inlet guide vanes of a gas turbine or compressor of a gas turbine. However, the principle of the invention may also be applied to any other type of hydraulic or pneumatic actuator and any other type of related engine components, which are to be actuated. For the closing operation of the actuator 10, the proportional valve 1 is set into the position shown in FIG. 1 such that a pressurized hydraulic fluid is guided from a supply into the hydraulic line 6, whereby a valve 4 is in an open condition such that the actuator is moved into the closed position, as indicated in FIG. 1 by the arrow beside the actuator 10. On the side of the drain line 7, the hydraulic liquid flows back to the tank of the hydraulic system via the open valve 14 and the proportional control valve 1.

On the other hand, as shown in FIG. 2, during the opening of the hydraulic actuator 10, the proportional valve 1 is switched into another position: the flow direction of the hydraulic liquid between the hydraulic liquid supply means and the tank is thereby reversed, still with the valves 4, 14 in an open state, such that the piston of the hydraulic actuator 10 is moved back into the open position (cf. arrow beside the actuator 10 in FIG. 2).

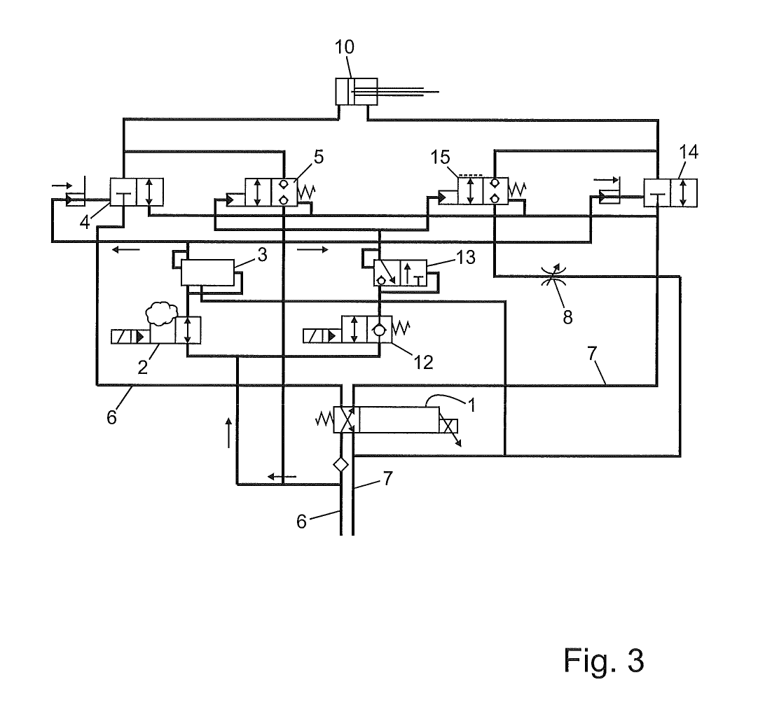

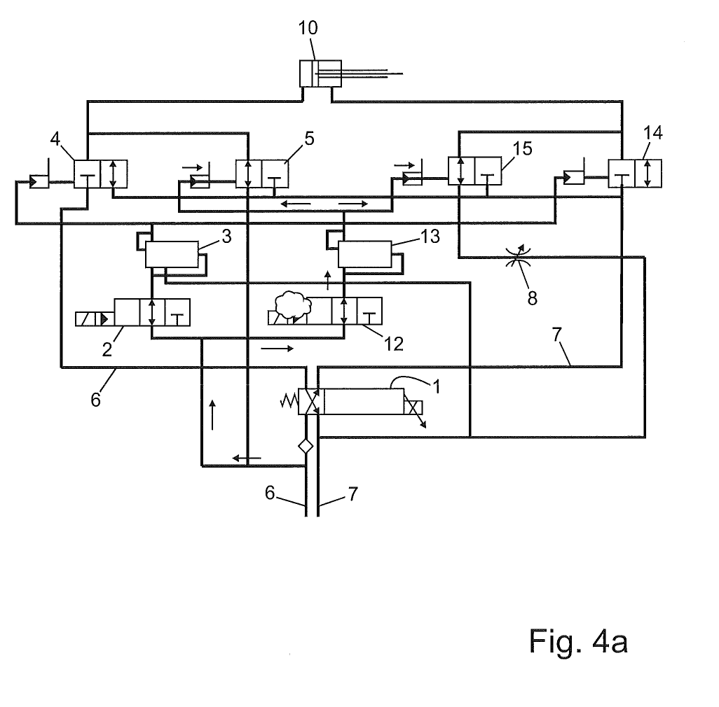

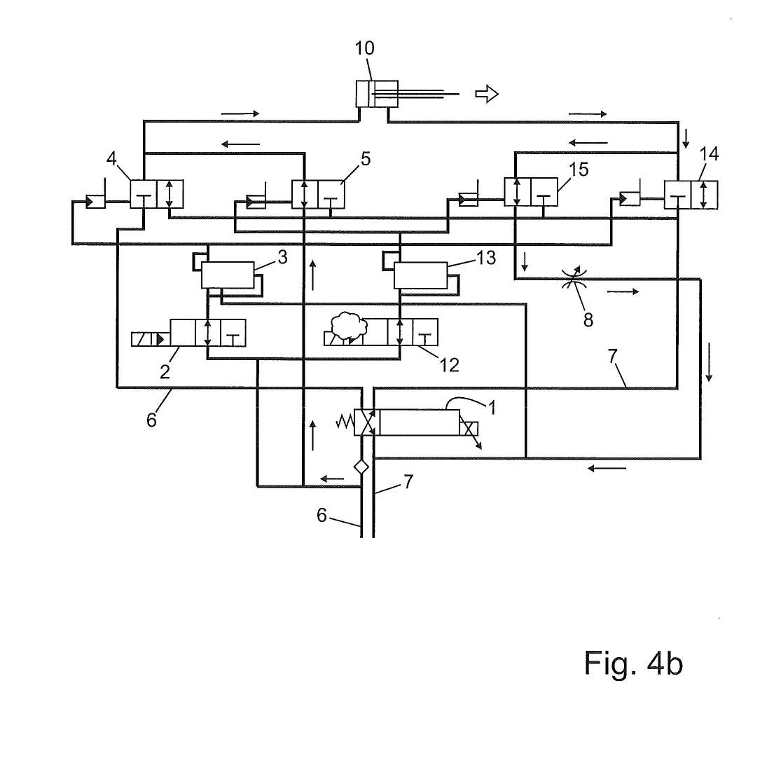

According to the invention, this hydraulic device is in addition to this normal operation cycle provided with an emergency operation cycle including a plurality of different valves and additional hydraulic lines, as shown in the drawings: when a failure of a component or with regard to sensor data occurs in the hydraulic system, the proportional valve 1 is put out of action, and different emergency operation mode is executed, as explained in connection with FIGS. 3, 4a and 4b.

The device for an emergency operation according to the invention is used in case of a system failure, in particular with regard to the position of engine components and the actuator, the proportional valve itself or electronic components of the system, e.g. transducers, angle position transducers supplying bad data quality. Also in case of other types of failure in the (normal) hydraulic system, the emergency cycle according to the invention is used to bring the hydraulic actuator 10 (or pneumatic actuator) and the connected engine parts into a required safe position. By means of such an emergency operation, any damages to machine parts are avoided, and the shut-down of a gas turbine, for example, can be realized in a controlled and safe manner. The emergency cycle of the device according to the invention includes several additional valves and connecting hydraulic lines attached to the normal hydraulic operation cycle, as described with regard to the above FIGS. 1 and 2.

The schematic hydraulic diagram of FIG. 3 shows a first example of realization of an emergency operation modus, in which the emergency cycle brings the hydraulic actuator 10 in a blocked position. The emergency cycle of this embodiment as shown in FIG. 3 includes two solenoid valves 2, 12, two hydraulically operated valves 3, 13, which are connected to the solenoid valves 2, 12, which can also be referred to as signal switch valves. Furthermore, two hydraulically operated valves 4, 14 and two hydraulically operated valves 5, 15 are provided, which are depending on the emergency operation modus activated by means of the signal switch valves, i.e. the solenoid valves 2, 12, and which can also be referred to as directly operated valves of the emergency cycle.

In the emergency operation blocking modus, as shown in FIG. 3, the first solenoid valve 2 is activated (opened). The valve 13 is in an open state, whereas the valves 4, 14, which are connected to the valve 3, are closed. Due to this closing of the hydraulically operated valves 4, 14, the hydraulic actuator 10 is brought into a blocked position, which is a position that has been given upon occurrence of the failure in the system. Any further movement of the activator 10 is thereby prevented. As can be seen from the schematic hydraulic diagram of FIG. 3, in this situation the proportional valve 1 used for the normal control of the actuator 10 is bypassed in this emergency operation modus due to the additional hydraulic lines between the supply of pressurized hydraulic liquid and the different valves of the emergency cycle. The emergency cycle of this example of realization according to the invention is furthermore provided with a flow control valve 8, which is, for example, a manually adjustable orifice. By means of this flow control valve 8, the emergency switching speed can be set, for example the closing rate or closing speed, in case that the device for an emergency operation is used for putting the actuator into a closed position.

The actuation of the solenoid valve 2 for initiating the emergency operation blocking modus can be made automatically by means of adapted control means of the system and upon assessment of a failure or bad data in the sensors of the hydraulic system. Also in case of any problems with regard to the proportional valve or its electronic card and in case of missing feedback signals concerning an actual position of an engine component, which is connected to the hydraulic actuator 10, the emergency operation can be initiated by means of a switching of the solenoid valve 2. This switching of the solenoid valve 2 leads to an activation impulse to the hydraulically operated valves in order to put these valves into the respective required position for realizing the emergency operation modus according to the invention. When the solenoid valve 2 is switched, the emergency operation blocking modus is immediately initiated, and the position of the hydraulic actuator 10 will be blocked in its actual position and independently of the position of the proportional valve 1, which is bypassed in such a situation.

In case of an alternative emergency modus according to the invention, the hydraulic actuator 10 is not blocked, but is put into a predetermined safe position. Such an emergency closing operation modus of a device according to the invention is shown in the schematic hydraulic diagrams of FIG. 4a and FIG. 4b. FIG. 4a shows for the purpose of comprehension only a situation, which is only present a very short time (part 1 of closing operation) before the final closing of the hydraulic actuator 10 takes place, as shown in FIG. 4b (part 2 of closing operation).

Also in this case, the emergency cycle is adapted to bypass the proportional valve 1 of the normal operation cycle, i.e. to put it out of action. The emergency operation closing modus is initiated by a simultaneous activation of the first solenoid valve 2 and the second solenoid valve 12. The hydraulically operated valve 13 opens, and thereby also the hydraulically operated valves 5, 15 will be switched into the open state (cf. FIG. 4a). Because of the opening of the valves 5, 15 and due to the bypassing of the proportional valve 1, the hydraulic actuator 10 is moved into its closed position, as shown by means of the thickened hydraulic lines and flow arrows in FIG. 4b. For example, in case that the hydraulic actuator 10 is used for the actuation of variable inlet guide vanes of a gas turbine, this closing of the inlet guide vanes is required due to safety specifications: in case of a failure in the hydraulic system or a part of the hydraulic system, the actuator is safely moved into its closed position by means of the device for an emergency operation according to the invention with the structure and components described in this specification. Hereby, damages to engine parts and parts of the gas turbine are avoided. The safe rundown of the gas turbine and its components, in particular the compressor, is thereby guaranteed.

Also here, the emergency cycle is provided with a flow control valve 8 in the drain line 7 to the tank of the hydraulic cycle. With the adjustment of such flow control valve, the speed of the piston of the actuator for work in emergency modus can be defined as required. For example, an emergency closing rate of the above-mentioned variable inlet guide vanes can hereby be adjusted. The flow control valve can be realized in any type of flow control valve known to a person skilled in the art, and in particular by means of a manually adjustable orifice.

Also here, the solenoid valves 2, 12 can be activated manually or can be activated automatically by an appropriate control means of the device (not shown in the drawings). The invention is not limited to only hydraulic actuators, but can also be applied to pneumatic actuators. The invention as described by means of an example of realization is not limited to the structure and components described in relation to the drawings. The device can have further additional means or can be different as regards the number of hydraulically operated valves or with respect to the solenoid valves, as long as the emergency cycle is adapted to bypass the normal control proportional valve 1 and to put the actuator 10 into a safe predefined emergency position. Such a position of the actuator in the emergency operation modus can be a blocked position, such as in the case of FIG. 3, or a closed position, such as in FIGS. 4a, 4b, or an open position, depending on the requirements and the respective types of engine or gas turbines, to which the device according to the invention is applied.

1. A device for emergency operation of pneumatic or hydraulic actuators, which have for normal operation of the actuator an operation cycle; the device comprising: at least a proportional valve for switching to different operational conditions of said actuator and related engine components, the proportional valve being arranged in a supply line of pressurized liquid/gas and in a drain line connected to a tank, and control means for operation control and supervising functions, wherein an emergency cycle is attached to said operation cycle of said actuator which is provided with at least one solenoid valve for initiating an emergency operation impulse in case of detected failures, a plurality of pneumatically/hydraulically operated switch valves which may be activated through said impulse of an emergency signal from said solenoid valve, and whereby the emergency cycle is adapted to bypass said proportional valve in emergency situations and to either block said actuator in its actual position or to bring said actuator in a predefined safe position.

2. The device according to claim 1, further comprising means for the detection of a correct functioning of said actuator are provided for supplying an input signal or emergency signal to said control means.

3. The device according to claim 1, wherein said control means are connected to said at least one solenoid valve for automatically switching to an emergency operation in case of failures in the normal operation modus of said actuator.

4. The device according to claim 1, further comprising a first solenoid valve wherein upon activation of said first solenoid, said actuator is blocked in its actual position.

5. The device according to claim 1, further comprising a first solenoid valve and a second solenoid valve wherein upon simultaneous activation of them said actuator is brought into a predefined safe position, in particular an end position.

6. The device according to claim 5, wherein said predefined safe position is an extended position of said actuator corresponding in particular to a closed position of related engine components.

7. The device according to claim 1, wherein said emergency cycle comprises a flow control valve for adjusting a switching speed from normal operation to emergency operation.

8. The device according to claim 1, wherein said control means are adapted to interrupt the emergency operation and resume normal operation upon request of a user.

9. The device according to claim 1, further comprising a detector for supervising the position of said proportional valve is provided.

10. The device according to claim 1, wherein said actuator is a hydraulic actuator of variable inlet guide vanes of a gas turbine.
